(19) United States
(12) Patent Application Publication
(10) Pub. No.: US 2020/0184386 A1
(43) Pub. Date: Jun. 11, 2020

(54) SYSTEMS TO RESOLVE SHIPMENT DELAYS

(71) Applicant: HEWLETT-PACKARD DEVELOPMENT COMPANY, L.P., Houston, TX (US)

(72) Inventors: Paul Hooghwerff, Amstelveen (NL); Ricardo De la Torre Silva, Tlaquepaque (MX); Arturo Xavier Parada Silva, Tlaquepaque (MX); Jose De Jesus Munoz Cazola, Tlaquepaque (MX); Hiem Wee Tan, Singapore (SG); Christoph George Theodor Steinke, Boeblingen (DE); Marek Jobda, Warsaw (PL)

(21) Appl. No.: 16/214,568

(22) Filed: Dec. 10, 2018

(51) Int. Cl. G06Q 10/06; G06Q 10/08; G06F 9/54; G06F 16/25; G06F 16/22

(52) U.S. Cl. CPC G06Q 10/063; G06Q 10/0833; G06Q 50/28; G06F 16/258; G06F 16/2282; G06F 9/542

(57) ABSTRACT

In example implementations, an apparatus is provided. The apparatus includes a shipment delay detection component, a root cause identification component, a data scrubber, and a notification generator. The shipment delay detection component is to detect a shipment delay of an order. The root cause identification component is to identify a root cause of the shipment delay. The data scrubber is to initiate a communication session with a server in a region associated with the root cause to obtain missing data. The notification generator is to generate a notification comprising the root cause and the missing data.

### BACKGROUND

Businesses ship billions of goods around the world. For example, the orders may be routed from a point of sale to different shipment warehouses located around the world. Software may calculate the best warehouse to ship the product from based on a location of the customer. Some products may be shipped internationally and routed through different countries.

### BRIEF DESCRIPTION OF THE DRAWINGS

FIG. 1 illustrates an example network of the present disclosure;

FIG. 2 illustrates a block diagram of an example system to resolve shipment delays in the example network of the present disclosure;

FIG. 3 illustrates an example graphical user interface of an application of the present disclosure;

FIG. 4 is an example flow diagram of a method to automatically resolve shipment delays of the present disclosure; and

FIG. 5 is a block diagram of an example non-transitory computer readable storage medium storing instructions executed by a processor to resolve shipment delays of the present disclosure.

### DETAILED DESCRIPTION

Examples described herein provide a system and method to resolve system shipment delays. As discussed above, businesses ship billions of good around the world. Customers are increasingly demanding that products arrive faster and on time. However, shipping products internationally can face several hurdles. For example, each region may have different customs and practices and collect data differently.

In addition, there may be several different regions and countries within each region that may not communicate with one another when a shipment delay is reported. Many times, the delay may simply be identified as a customs issue. However, the root cause of the shipment delay may have occurred in an earlier part of the shipment processes due to missing data. Identifying the root cause, finding the data, and generating a notification including the root cause and missing data for verification may prevent future shipment delays.

Examples herein provide a system that can centralize data from a plurality of different regions. The system may detect shipment delays and initiate a process to identify a root cause and find missing data that may have caused the shipment delay. A notification may be created that may allow a team to verify the information.

In an example, the system may be customizable. For example, data entry for each region may be customized to be aligned with the customs and procedures of a particular region. The system may automatically format the data to be presented in a streamlined manner in a graphical user interface of the system. Thus, the system may improve information technology that is associated with business logistics in shipping products globally across the world.

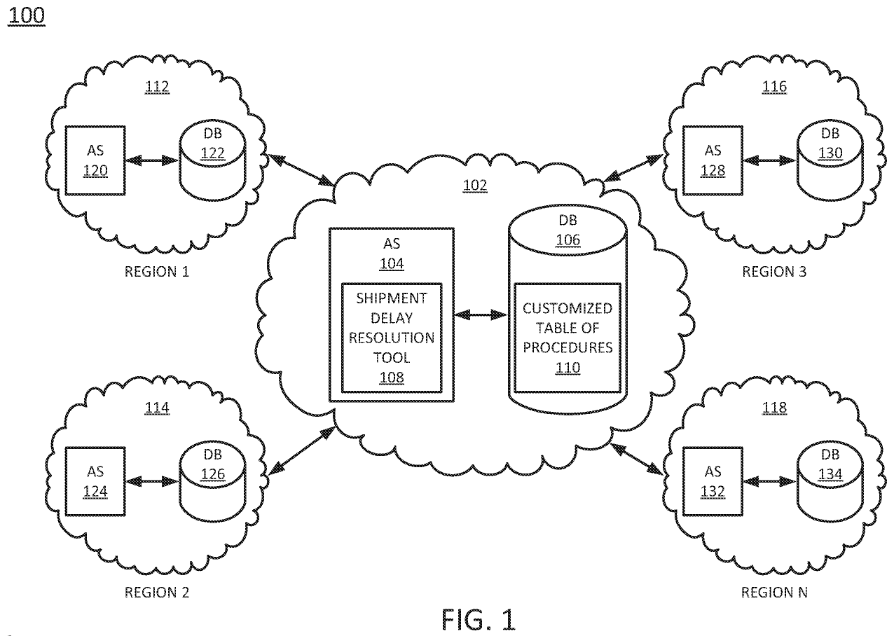

FIG. 1 illustrates an example system 100 to automatically resolve shipment delays of the present disclosure. In one example, the system 100 may include a communications network 102. The communications network 102 may be an Internet protocol (IP) network.

It should be noted that the communications network 102 is simplified for ease of explanation. The communications network 102 may include additional network elements that are not shown. For example, the communications network 102 may include routers, switches, gateways, border elements, firewalls, and the like. The communications network 102 may include additional access networks that are not shown. For example, the communications network 102 may include a broadband access network, a cellular access network, and the like.

In one example, the communications network 102 may include an application server (AS) 104 and a database (DB) 106. The AS 104 and the DB 106 may be a centralized server and database that is managed and operated by an enterprise. The AS 104 and the DB 106 may be used to communicate with a plurality of different regions 112, 114, 116, and 118. Although four regions are shown in FIG. 1, it should be noted that there may be hundreds of different regions. For example, each region 112, 114, 116, and 118 may represent a different geographic location. Each region 112, 114, 116, and 118 may be located at a customs checkpoint where shipments may be inspected before crossing an international border. Although the examples below are described within the context of the regions 112, 114, 116, and 118 being a customs checkpoint, it should be noted that the present disclosure may apply to shipment delays that may occur, or potentially occur, at any point within a shipping process or logistics.

In one example, each region 112, 114, 116, and 118 may include a respective AS and DB. For example, the region 112 may include an AS 120 and a DB 122, the region 114 may include an AS 124 and a DB 126, the region 116 may include an AS 128 and a DB 130, and the region 118 may include an AS 132 and a DB 134. In one example, the AS 120, 124, 128, and 132 may collect and process customs data for shipments that pass through the respective regions 112, 114, 116, and 118. The AS 120, 124, 128, and 132 may collect and process data in accordance with a particular way that each region 112, 114, 116, and 118 may collect and process data. The data may be stored in the DB 122, 126, 130, and 134 of the respective regions 112, 114, 116, and 118.

The AS 120, 124, 128, and 132 may be controlled or operated by a broker in the respective region 112, 114, 116, and 118 that is responsible for the shipment of an order. Although a single AS 120, 124, 128, and 132 and a single DB 122, 126, 130, and 134 are shown in each region 112, 114, 116, and 118, it should be noted that each region may include any number of application servers and databases. For example, each region 112, 114, 116, and 118 may include multiple different brokers.

In one example, the AS 104 and the DB 106 may manage, monitor, and automatically resolve shipment delays that may be detected at the regions 112, 114, 116, and 118 and reported to the AS 104 and the DB 106. In one example, the AS 104 may include a processor and a memory that stores instructions executed by the processor to perform the functions described below. The DB 106 may store data and rules that can be customized based on a particular application or process flow of the enterprise. The AS 120, 124, 128, and 132 may also include a processor and memory.

The AS 104 may provide a centralized customizable solution that may efficiently provide information regarding shipment delays and advisories in a plurality different regions 112, 114, 116, and 118. For example, previously, no centralized system existed that can collect data in different formats and format the data into a standard format that can be processed and shown in a streamlined GUI. Rather, previously each region 112, 114, 116, and 118 may have independently managed shipment delays. The system 100 of the present disclosure solves these technical issues with previous arrangements for managing, monitoring, and trying to resolve shipment delays by providing a system 100 that automatically resolves shipment delays and provides a centralized system for the regions 112, 114, 116, and 118.

In one example, the AS 104 may include a shipment delay resolution tool (SDRT) 108. The SDRT 108 may monitor, manage, and automatically resolve shipment delays, as disclosed herein. The SDRT 108 may communicate automatically with the different regions 112, 114, 116, 118 to obtain data, identify root causes, and resolve shipment delays. The SDRT 108 may convert data that is entered differently at each AS 120, 124, 128, and 132 into a common format that is used by the SDRT 108.

In one example, when a shipment delay is detected by the SDRT 108 the SDRT 108 may initiate communications with the AS 120, 124, 128, and/or 132 in the respective regions 112, 114, 116, and 118. The SDRT 108 may scrub the data in the AS 120, 124, 128 and/or 132 and the DB 122, 126, 130, and/or 134 to identify a root cause of the shipment delay.

In one example, the SDRT 108 may check the data logs in the regions 112, 114, 116, and 118 to identify a root cause of the shipment delay. In one example, the DB 106 may include a customized table of procedures 110. The AS 104 may compare the data logs to information in the customized table of procedures 110. The information may be shipment procedures for a particular region. The AS 104 may identify a root cause due to a missing step in the procedure of a particular region 112, 114, 116, or 118, missing data in a form used to ship the order at particular region 112, 114, 116, or 118, and the like. The AS 104 may also identify a particular broker in a particular region if multiple brokers are located in the region.

The customized table of procedures 110 may be customizable to include various different categories that may be examined, different requirements for hundreds of different regions and countries, different key performance indicators, and the like. In addition, the customized table of procedures 110 may allow the SDRT 108 to be integrated with existing systems or other types of source system data that can be used to modify the customized table of procedures 110. As a result, as the known processes for each region change, the customized table of procedures 110 may be easily modified such that the AS 104 may accurately identify the root cause of a shipment delay and automatically resolve the shipment delay.

In one example, if the root cause is due to an incorrectly filed form (e.g., missing data in an invoice, a shipment form, a customs form, and the like), the SDRT 108 may communicate with the appropriate AS 120, 124, 128 and/or 132 (or an appropriate server of a particular broker in one of the regions 112, 114, 116, or 118) to obtain the missing data. The SDRT 108 may then automatically generate a corrected form with the obtained data.

In one example, the SDRT 108 may generate a notification. The notification may include the root cause that was identified and the missing data (e.g., the corrected form generated by the SDRT 108). The notification may be sent to a respective region 112, 114, 116, and 118, and/or a particular server of a particular broker if multiple brokers are located within a single region, where the shipment delay occurred. In one example, once the shipment delay is resolved the respective AS 120, 124, 128, or 132 may send a notification back to the AS 104 to update a status of the shipment delay.

In one example, the DB 106 may also include a list of authorized users that may access the SDRT 108 and the associated authorization credentials, error codes, forms, and the like. As noted above, the system 100 provides a customizable solution that may allow changes to the list of authorized users, to allow error codes to be added and changed, authorization credentials to be changed, and the like.

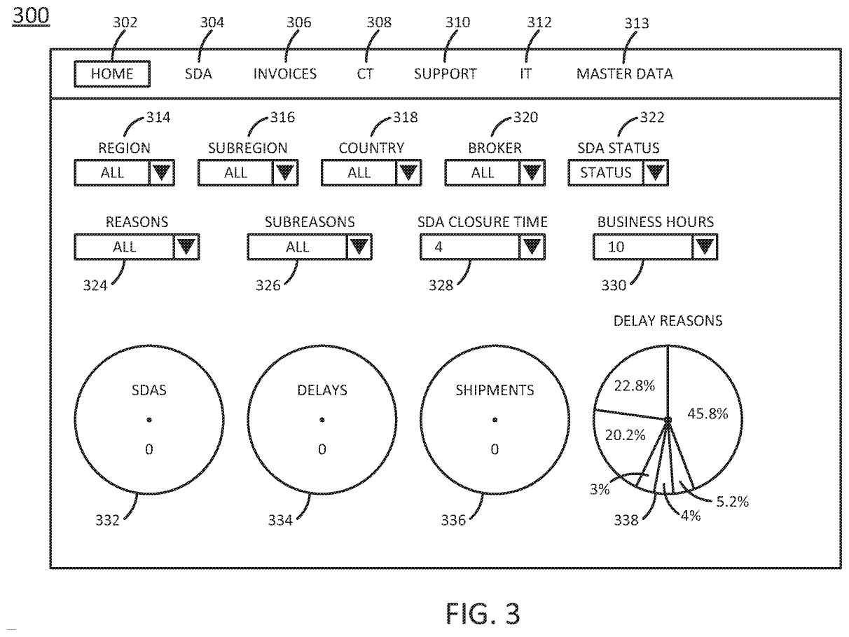

In addition, the SDRT 108 may provide a graphical user interface (GUI) that provides large amounts of information in a streamlined and efficient manner. For example, looking at data from different interfaces of different regions may be difficult. The SDRT 108 may resolve this technical problem by providing a GUI that can consolidate information into a single unified view. An example of the GUI is illustrated in FIG. 3 and discussed in further details below.

In addition, the GUI can be a web based application. As a result, a user may access the information from the SDRT 108 via any endpoint device. Thus, a technician may be located anywhere or may be away from the AS 104 and still access the GUI of the SDRT 108.

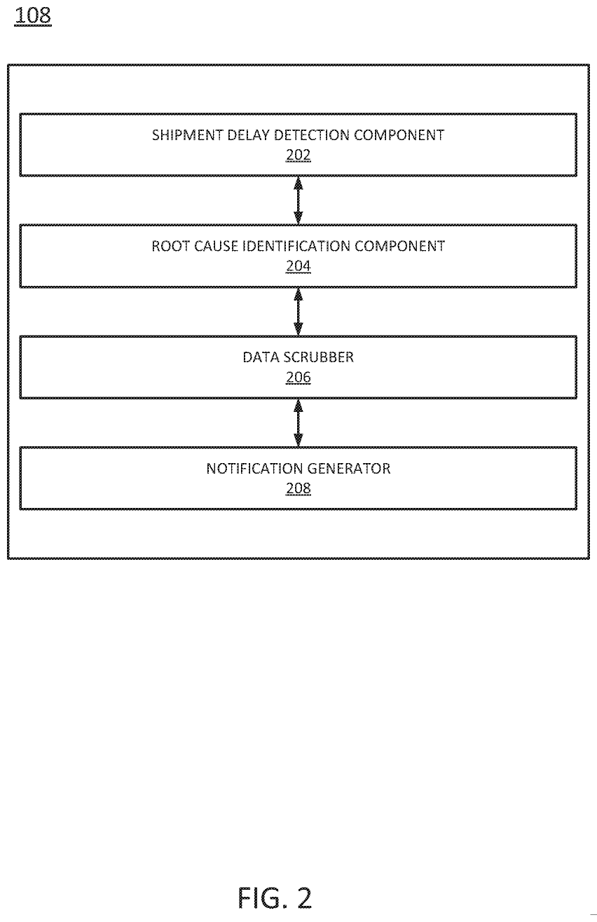

FIG. 2 illustrates an example of the SDRT 108. In one example, the SDRT 108 may include a shipment delay detection component 202, a root cause identification component 204, a data scrubber 206, and a notification generator 208. The shipment delay detection component 202, the root cause identification component 204, the data scrubber 205, and the notification generator 208 may be deployed as a combination of hardware or physical interfaces and instructions stored on a non-transitory computer readable medium that are executed by a processor.

In one example, the shipment delay detection component 202 may detect a shipment delay of an order at customs. For example, the shipment delay detection component 202 may include a communication interface to the AS 120, 124, 128, and 132 of each respective region 112, 114, 116, and 118. As shipment delays for orders are reported to the AS 104, the shipment delay detection component 202 may intercept or receive the shipment delays.

In one example, the root cause identification component 204 may include instructions stored in memory to identify a root cause of the shipment delay. For example, the root cause identification component 204 may analyze the shipment delay to determine which region 112, 114, 116, and 118 the shipment delay originated from. For example, the shipment delay may be transmitted from the AS 120 of the region 112. The root cause identification component 204 may compare shipment logs or data logs from the region 112 to procedures associated with the region 112 stored in the customized table of procedures 110. The root cause identification component 204 may identify a missing form or missing data from an incomplete form that may have caused the shipment delay.

In one example, the data scrubber 206 may include a communication interface to the AS 120, 124, 128, and 132. The communication interface may be a dedicated communication path to scrub the AS 120, 124, 128, and 132 to search for the missing data. For example, the dedicated communication path may ensure reporting of events, logs, other shipment delays, and the like, from the AS 120, 124, 128, and 132 to the AS 104 are not interrupted.

In one example, the dedicated communication path may also provide a secure path to transmit data. For example, the dedicated communication path may be a virtual private network (VPN) line that is established in response to an initiation of the process to identify the root cause of a shipment delay. The data that is exchanged may be sensitive or private and the dedicated communication path may also ensure that the data is not stolen or hacked during transmission.

In one example, the dedicated communication path may be temporarily created and torn down under the control of the root cause identification component 204. For example, when the root cause identification component 204 identifies a particular region that is the source of the shipment delay, the root cause identification component 204 may cause the data scrubber 206 to establish the dedicated communication path to the AS in the particular region (e.g., the AS 120 in the region 112 using the example above). After the missing data is obtained, the dedicated communication path may be torn down.

In one example, the notification generator 208 may generate a notification comprising the root cause and the missing data. For example, the missing data may be included in a corrected form generated by the SDRT 108, as discussed above. In one example, the notification generator 208 may transmit the notification to the respective AS of the region that is source of the shipment delay (e.g., the AS 120 of the region 112 in the example above).

The notification may allow users at the region 112 to study the root cause and prevent the root cause from causing another shipment delay in the future. As a result, overall logistics for shipments may be improved over time to prevent future shipment delays caused by a similar root cause. Once the shipment delay is resolved, the AS 120 may send a notification back to the AS 104 to indicate that the shipment delay is resolved. The notification may be logged and the status of the shipment delay may be updated in the SDRT 108.

In one example, new procedures may be implemented based on the resolution of the shipment delay. The AS 104 may automatically customize the customized table of procedures 110 with the new procedures that are applied in the resolution of the shipment delay of an order. Thus, the AS 104 may automatically resolve shipment delays and also automatically customize the customized table of procedures 110 used to identify root causes of a shipment delay in a feedback loop.

In one example, the SDRT 108 may also include a formatting component. The formatting component may convert data in different formats from the different regions 112, 114, 116, and 118 into a standardized format used by the SDRT 108. In one example, the standardized format may include converting data into a common language, grouping data into a particular data set, converting data into a particular measurement unit (e.g., SI units into English units, or vice versa), formatting data to have a particular alignment (e.g., right align versus center alignment), converting data into a particular format (e.g., Unicode data versus ASCII data, and the like), and so forth. Thus, each region 112, 114, 116, and 118 may collect and enter data in accordance with each region's customs. The formatting component of the SDRT 108 may then convert the data to allow for more efficient sorting, searching, and processing of the data. For example, the formatted data may then be presented in a GUI of the SDRT, as discussed in further details below.

FIG. 3 illustrates an example of a GUI 300 of the SDRT 108. In one example, the GUI 300 may include a variety of different pages and/or links. For example, the GUI 300 may include a home page 302, a shipment delay advisory (SDA) page 304, an invoices page 306, a control tower (CT) page 308, a support page 310, an information technology (IT) page 312, and a master data page 313.

The example illustrated in FIG. 3 shows an example of the home page 302. In one example, the GUI 300 allows information gathered from hundreds of different regions and/or countries to be shown in an efficient manner on a single screen. For example, the GUI 300 may include a graphic 332 for a number of SDAs, a graphic 334 for a number of delays, a graphic 336 for a number of shipments, and a graphic 338 that shows a pie chart of different reasons for the shipment delays. As a result, a user may quickly gather and comprehend data from the hundreds of different regions and/or countries.

The GUI 300 may provide an overview or allow a user to drill down a very specific set of information. For example, the user may specify a region 314, a sub-region 316, a country 318, a broker 320, an SDA status 322, a reason 324, and a sub-reason 326. In addition, the GUI 300 may allow a user to view an SDA closure time 328 and/or business hours 330 that can be used to reflect the capacity to resolve reported SDA issues within the SDA closure time window that is selected.

The SDA page 304 may list the SDAs that are reported by the various AS's 120, 124, 128, and 132 in the respective regions 112, 114, 116, and 118. The Invoices page 306 may show invoices of the orders having a shipment delay.

The CT page 308 may provide information associated with a particular control tower. The CT page 308 may be used to search and track the progress of a resolution for a particular shipment delay. The CT page 308 can be used to assign tasks and/or root causes to the support page 310 and the IT page 312. The CT page 308 can automatically assign root causes to the support groups responsible for the root cause. The CT page 308 may assign delay reasons to open root causes if the delay reasons are caused by the same root cause (e.g., for root causes which are flagged as a structure issue and/or delay reason root cause time stamp is within the boundaries of the root cause ticket).

In one example, the support page 310 may be used for business support. The support page 310 may reflect all assigned tasks to a business group to assist in solving a root cause for a particular delay reason if the SDRT 108 is unable to automatically determine a root cause and resolve the shipment delay. The support page 310 may show all impacted shipment and/or delay reasons for a root cause.

In one example, the IT page 312 may be used for information technology personnel and show similar information as the support page 310. For example, the IT page 312 may reflect all assigned tasks to an IT group to assist in solving a root cause for a particular delay reason if the SDRT 108 is unable to automatically determine a root cause and resolve the shipment delay. The IT page 312 may show all impacted shipment and/or delay reasons for a root cause. The IT page 312 may also reflect external status of IT service requests. The IT service request can be automatically logged to an assigned IT department via the SDRT 108. The SDRT 108 may also check a status and/or provide updates on the external IT tickets and/or SDA IT tickets automatically.

In one example, the master data page 313 may allow a user to update or further customize the customized table of procedures 110, the GUI 300, the different available pages of the GUI 300, the available options within each one of the pages of the GUI 300, and the like. The master data page 313 may use log in credentials for authorized personnel. For example, the customized table of procedures 110 and the GUI 300 may be modified by certain users with the appropriate credentials.

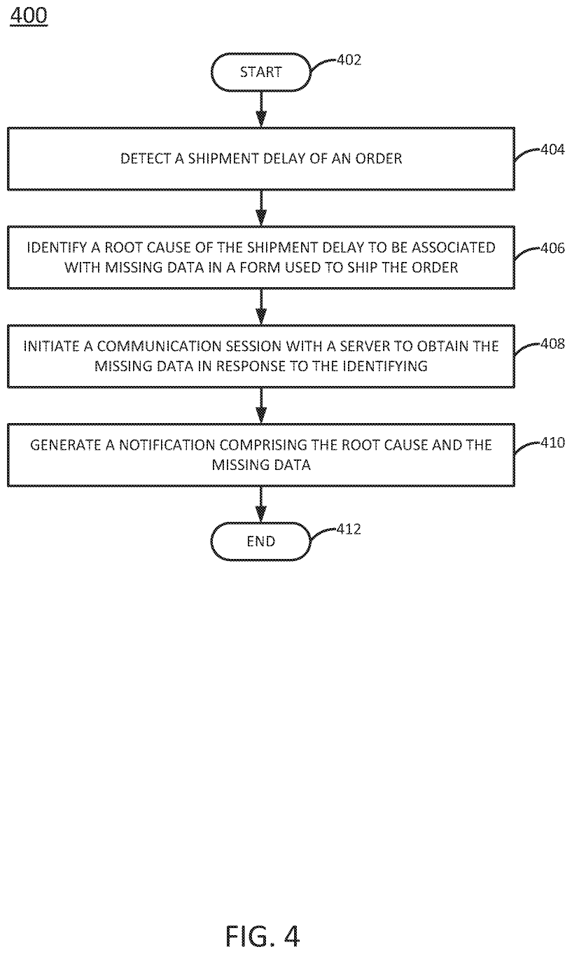

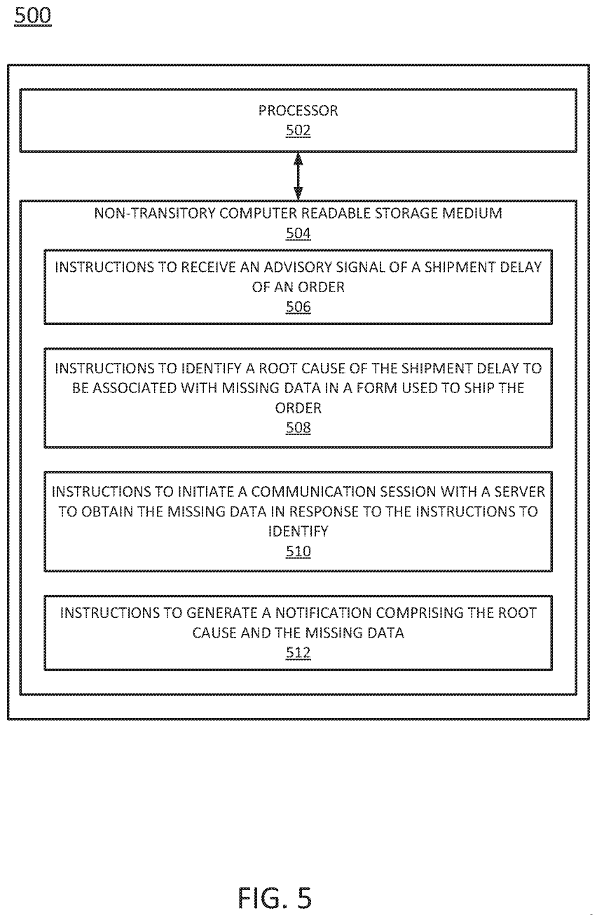

FIG. 4 illustrates a flow diagram of an example method 400 for automatically resolving shipment delays of the present disclosure. In an example, the method 400 may be performed by the AS 104, the shipment delay resolution tool 108, or the apparatus 500 illustrated in FIG. 5, and described below.

The method 400 begins at block 402. At block 404, the method 400 detects a shipment delay of an order. The shipment delay may be for an actual shipment delay or a potential shipment delay. In one example, the method 400 may apply for shipment delays of an order at customs. However, it should be noted that the shipment delay may be detected for any point along the shipping logistics or process.

In one example, a notification of the shipment delay may be reported by a server in the region where the shipment delay occurred. A SDRT of a centralized application server may receive the notification and initiate an automated procedure to resolve the shipment delay.

In one example, the shipment delay information and other data received from servers in the different regions may be formatted into a standardized format used by the SDRT. As a result, the SDRT may maintain flexibility for use in different regions that may have different procedures for entering data. However, the SDRT may format or convert the data into a standardized format that can be processed together and shown in a GUI, as described above.

At block 406, the method 400 identifies a root cause of the shipment delay to be associated with missing data in a form used to ship the order. In one example, a communication path with a server in the region where the shipment delay occurred may be established. The centralized application server may analyze data logs, shipment logs or data, and the like, on the server. A procedure associated with shipping an order in that region may be determined. The known procedure may be obtained from a customized table of procedures. The information from the server in the region where the shipment delay occurred (e.g., shipment data) may be compared to the known procedure. Based on the comparison the root cause may be identified or determined based on a missing step, a missing form, missing data in an incomplete or rejected form, and the like.

At block 408, the method 400 initiates a communication session with a server to obtain the missing data in response to the identifying. In one example, the root cause may be due to missing data in an incomplete or rejected form or a form may be missing. A dedicated communication path may be established between the centralized application server and a server at a region that is identified as the source of the shipment delay.

In one example, the missing data may be found in other forms associated with the shipment that is delayed, from data entered by a user, from invoices or order forms, and the like. For example, the centralized application server may identify which information is missing and use a search in the server based on keywords associated with the information that is missing. For example, if a product SKU number is missing the centralized application server may search for “SKU” in other data available on the server. In another example, if a product origin address is missing the centralized application server may search for “address,” “sender,” and the like. After the missing data is found, the centralized application server may generate a corrected form with the missing data.

At block 410, the method 400 generates a notification comprising the root cause and the missing data. In one example, the missing data may be included in the corrected form that is generated by the centralized application server. The notification may be transmitted back to the server at the region where the shipment delay originated. The notification may be processed by the server at the region where the shipment delay originated and the shipment delay may be resolved. When the shipment delay is resolved, the server may transmit a response notification back to the centralized application server that the shipment delay is resolved. The centralized application server may then update a status of the shipment delay in the SDRT and the information may be updated in the GUI. At block 412, the method 400 ends.

FIG. 5 illustrates an example of an apparatus 500. In an example, the apparatus 500 may be the AS 104 or the shipment delay resolution tool 108. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include instructions to receive an advisory signal of a shipment delay of an order at customs. The instructions 508 may include instructions to identify a root cause of the shipment delay to be associated with missing data in a form used to ship the order. The instructions 510 may include instructions to initiate a communication session with a server to obtain the missing data in response to the instructions to identify. The instructions 512 may include instructions to generate a notification comprising the root cause and the missing data.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a shipment delay detection component to detect a shipment delay of an order;
a root cause identification component to identify a root cause of the shipment delay;
a data scrubber to initiate a communication session with a server in a region associated with the root cause to obtain missing data; and
a notification generator to generate a notification comprising the root cause and the missing data.

2. The apparatus of claim 1, further comprising:
a memory to store a customizable table of procedures for shipment of each region, wherein the procedures are to identify the root cause.

3. The apparatus of claim 1, further comprising:
a communication interface to establish the communication session with the server and to establish a second communication session with an endpoint to transmit the notification.

4. The apparatus of claim 1, further comprising:
a formatting component to convert data entered in different formats in each region into a common format.

5. The apparatus of claim 4, further comprising:
a graphical user interface (GUI) generator to generate a GUI that presents the data in the common format.

6. The apparatus of claim 1, wherein the root cause is associated with the missing data in a form used to ship the order.

7. A method, comprising:
detecting, by a processor, a shipment delay of an order;
identifying, by the processor, a root cause of the shipment delay to be associated with missing data in a form used to ship the order;
initiating, by the processor, a communication session with a server to obtain the missing data in response to the identifying; and
generating, by the processor, a notification comprising the root cause and the missing data.

8. The method of claim 7, wherein the identifying comprises:
determining, by the processor, a procedure associated with shipping the order;
comparing, by the processor, shipment data associated with the order; and
determining, by the processor, the form that is incomplete from the shipment data to identify the root cause.

9. The method of claim 7, further comprising:
identifying, by the processor, a region associated with the root cause of the shipment delay, wherein the server is located in the region.

10. The method of claim 7, further comprising:
formatting, by the processor, data entered in different formats from a plurality of different regions into a common format.

11. The method of claim 10, further comprising:
displaying, by the processor, the data in the common format on a web application graphical user interface.

12. The method of claim 7, further comprising:
transmitting, by the processor, the notification to an endpoint device for verification.

13. The method of claim 12, further comprising:
receiving, by the processor, a signal indicating that a resolution to the shipment delay is completed; and
updating, by the processor, a status of the shipment delay as resolved in a graphical user interface (GUI).

14. The method of claim 13, wherein the notification is associated with the status of the shipment delay as being resolved in the GUI.

15. A non-transitory computer readable storage medium encoded with instructions executable by a processor, the non-transitory computer-readable storage medium comprising:
instructions to receive an advisory signal of a shipment delay of an order;
instructions to identify a root cause of the shipment delay to be associated with missing data in a form used to ship the order;
instructions to initiate a communication session with a server to obtain the missing data in response to the instructions to identify; and
instructions to generate a notification comprising the root cause and the missing data.

16. The non-transitory computer readable storage medium of claim 15, further comprising:
instructions to identify the missing data in a form in a known shipment procedure for the order.

17. The non-transitory computer readable storage medium of claim 15, further comprising:
instructions to identify a region associated with the root cause of the shipment delay.

18. The non-transitory computer readable storage medium of claim 17, wherein the server that the communication session is initiated with is in the region.

19. The non-transitory computer readable storage medium of claim 15, further comprising:
instructions to format data entered in different formats from a plurality of different regions into a common format.

20. The non-transitory computer readable storage medium of claim 19, further comprising:
instructions to display the data in the common format on a web application graphical user interface.
